(19) United States
(12) Patent Application Publication
(10) Pub. No.: US 2008/0123894 A1
(43) Pub. Date: May 29, 2008

(54) Expandable speaker apparatus

(76) Inventor: Chen-Chi Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/639,258

(22) Filed: Dec. 15, 2006

(30) Foreign Application Priority Data
Jun. 27, 2006 (TW) 95123136

(51) Int. Cl. H04R 1/02

(52) U.S. Cl. 381/394; 381/395

(57) ABSTRACT

An expandable speaker apparatus includes a speaker body, at least one first electrical connector, and at least one second electrical connector. The first electrical connector is located on a first surface of the speaker body. The second electrical connector is located on a second surface of the speaker body. The first electrical connector corresponds to the second electrical connector, and the first electrical connector is electrically connected with the second electrical connector. Thereby, the speaker body is electrically connected with a second speaker body using an electrical connector that is same as the pair of electrical connectors. The conducting line is not required, and the speaker apparatus is expandable.

### BACKGROUND OF THE INVENTION

1. Field of the Invention

The present invention relates to an expandable speaker apparatus. In particular, this expandable speaker apparatus includes at least a pair of electrical connectors that correspond to each other and are electrically connected together for connecting another speaker apparatus with the same electrical connector.

2. Description of the Related Art

Reference is made to FIG. 1, which is a schematic diagram of the connecting method for the speaker apparatus of the prior art. The first speaker body 1a is serially connected with the second speaker body 2a via a conducting line 3a. Thereby, the speaker apparatus is expanded.

However, when a plurality of speaker apparatuses are connected in serial, the connecting method of the prior art has some problems.

Firstly, it is inconvenient to assemble a plurality of speaker apparatuses via the conducting lines 3a. Secondly, the complex conducting lines are usually installed to the wrong locations.

### SUMMARY OF THE INVENTION

One particular aspect of the present invention is to provide an expandable speaker apparatus. At least one pair of electrical connectors are installed on the external surface of the speaker body for connecting another speaker body with the same electrical connector. Thereby, the speaker apparatus is expanded.

Another particular aspect of the present invention is to provide an expandable speaker apparatus. At least one pair of electrical connectors are installed on the external surface of the speaker body. It can be electrically connected with another speaker body with an electrical connector that corresponds to the pair of electrical connectors. The conducting line is not required. The problem of difficulty when assembling the speaker apparatus due to the complexity of the conducting lines is overcome.

The expandable speaker apparatus includes a speaker body, at least one first electrical connector, and at least one second electrical connector. The first electrical connector is located on a first surface of the speaker body. The second electrical connector is located on a second surface of the speaker body. The first electrical connector corresponds to the second electrical connector, and the first electrical connector is electrically connected with the second electrical connector.

The first electrical connector and the second electrical connector of the expandable speaker apparatus are adjacently or oppositely located on the speaker body.

The expandable speaker apparatus further includes at least one jointing structure. The jointing structure includes a first jointing part, and a second jointing part. The first jointing part is located on the first surface. The second jointing part is located on the second surface. The first jointing part and the second jointing part correspond to each other.

In a preferred embodiment, the jointing structure uses a magnetic attaching structure. The first jointing part and the second jointing part are a magnet-to-magnet set, or a magnet-to-metal set.

In a preferred embodiment, the jointing structure uses a tenon structure. The first jointing part and the second jointing part are a tenon-to-mortise set.

In another preferred embodiment, the expandable speaker apparatus further includes at least one concave trough and a convex column. The concave trough is located on the first surface. The convex column is located on the second surface. The first electrical connector includes at least two contacting pins. The contacting pins protrude outward from the external wall surface of the concave trough. The second electrical connector includes at least two contacting surfaces. The contacting surfaces are located on the external wall surface of the convex column. The contacting pins correspond to the contacting surface.

Alternatively, the contacting pins of the first electrical connector protrude outwards from the external wall surface of the convex column, and the contacting surfaces of the second electrical connector are located on the external wall surface of the concave trough.

In another preferred embodiment, the expandable speaker apparatus further includes at least one jointing structure having a first jointing part, and a second jointing part. The first jointing part is located on the concave trough or the convex column. The second jointing is located on the convex column or the concave trough. The first jointing part and the second jointing part correspond to each other.

In another preferred embodiment, the first electrical connector is a sound-plug connector, and the second electrical connector is a sound-socket connector. The sound-plug connector and the sound-socket connector are adjacently or oppositely located on the speaker body.

In another preferred embodiment, the sound-socket connector includes a sound pin and a grounding pin. The sound-plug connector includes a sound surface and a grounding surface. The sound pin corresponds to the sound surface, and the grounding pin corresponds to the grounding surface.

In another preferred embodiment, the speaker body includes a receiving slot. The receiving slot is located on the first surface. The sound-plug connector is bendedly received in the receiving slot.

In another preferred embodiment, the sound-plug connector includes at least two sound channels corresponding to the sound-socket connector.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the connecting method for the speaker apparatus of the prior art;

FIG. 2 is a schematic diagram of the expandable speaker apparatus of the first embodiment and another first embodiment of the present invention when not assembled;

FIG. 3 is a schematic diagram of the expandable speaker apparatus of the first embodiment and another first embodiment of the present invention when assembled;

FIG. 4 is another assembled schematic diagram of the expandable speaker apparatus of the first embodiment and another first embodiment of the present invention;

FIG. 5 is an assembled schematic diagram of the expandable speaker apparatus of the second embodiment and another second embodiment of the present invention;

FIG. 6 is an assembled schematic diagram of the expandable speaker apparatus of the third embodiment and another third embodiment of the present invention;

FIG. 7 is a schematic diagram of the expandable speaker apparatus of the fourth embodiment of the present invention;

FIG. 8 is a schematic diagram of the expandable speaker apparatus of the fifth embodiment of the present invention;

FIG. 8A is a schematic diagram of the expandable speaker apparatus of the sixth embodiment of the present invention;

FIG. 9 is a schematic diagram of the expandable speaker apparatus of the seventh embodiment of the present invention;

FIG. 9A is a schematic diagram of the expandable speaker apparatus of the eighth embodiment of the present invention;

FIG. 10 is a schematic diagram of the expandable speaker apparatus of the ninth embodiment of the present invention; and

FIG. 11 is a schematic diagram of the expandable speaker apparatus of the tenth embodiment of the present invention.

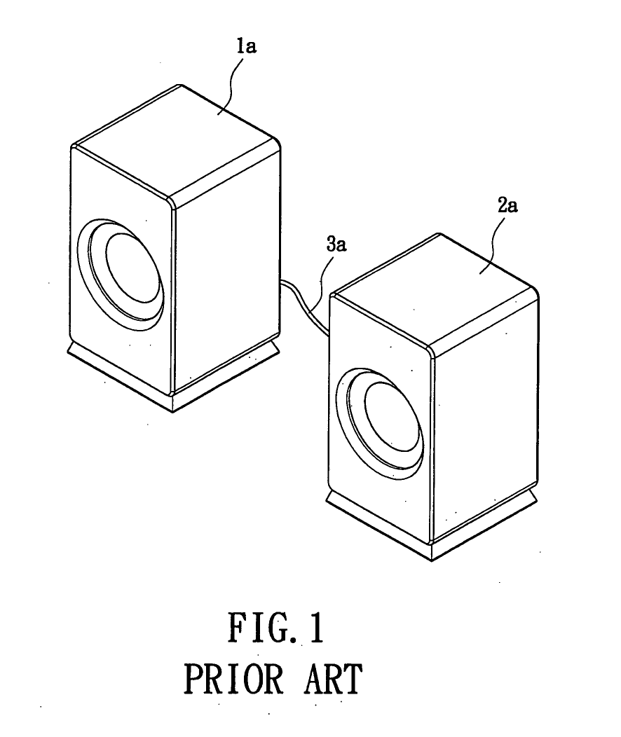

### DETAILED DESCRIPTION OF THE PREFERRED EMBODIMENTS

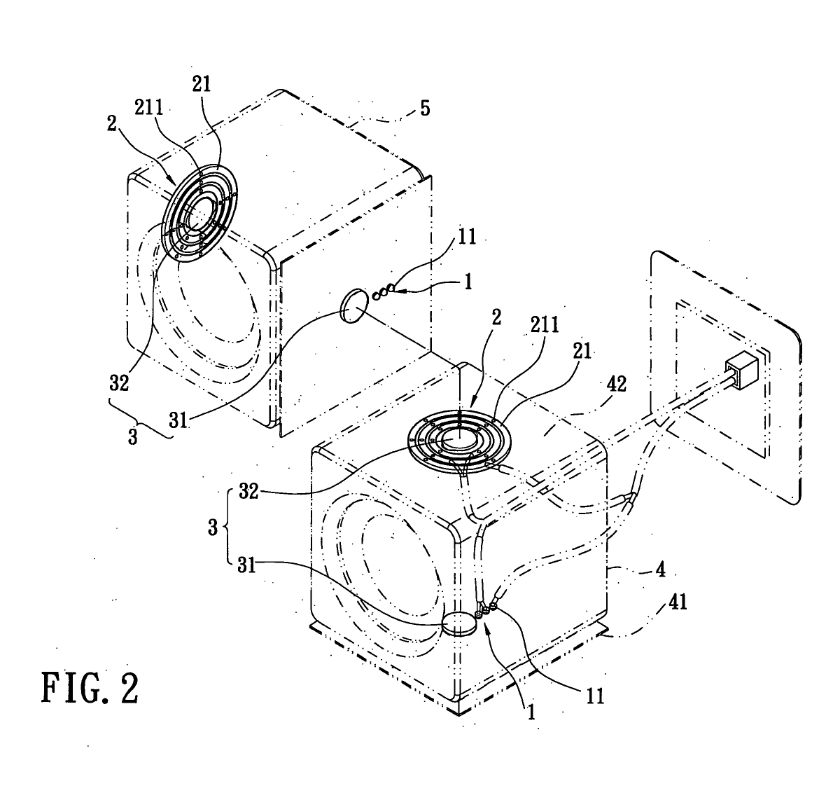

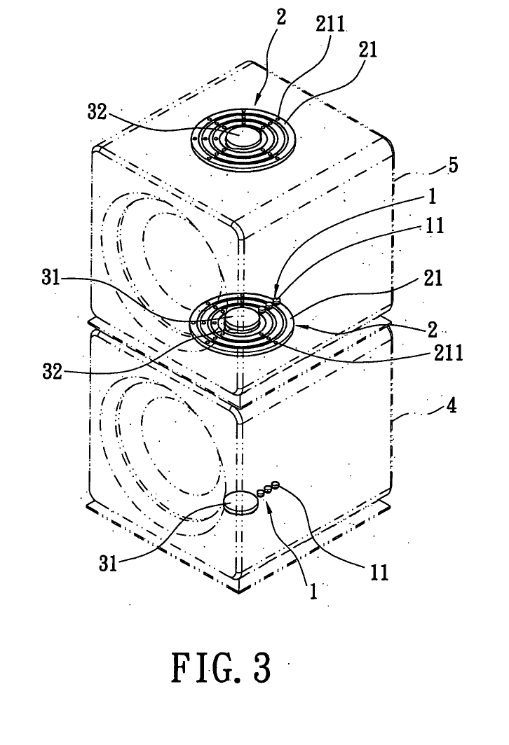

Reference is made to FIGS. 2 and 3, which show schematic diagrams of the expandable speaker apparatus of the first embodiment and another first embodiment of the present invention in unassembled and assembled states respectively. The expandable speaker apparatus includes a first electrical connector 1, a second electrical connector 2, a jointing structure 3, and a speaker body 4.

The first electrical connector 1 is located on a first surface 41 of the speaker body 4. The first surface 41 can be a bottom surface of the speaker body 4. The first electrical connector 1 can be used as a power output port or a power input port. The first electrical connector 1 includes at least two contacting pins 11. The contacting pins 11 protrude outwards from the first surface 41. The contacting pins comprise a sound pin (not labeled) and a grounding pin (not labeled). In this embodiment, there are three contacting pins 11. The contacting pins 11 are flexible pins, and are disposed on one line at a distance.

The second electrical connector 2 is located on a second surface 42 of the speaker body 4 that is opposite or adjacent to the first surface 41. In this embodiment, the second electrical connector 2 located on a second surface 42 of the speaker body 4 that is opposite to the first surface 41 is used as an example. The second surface 42 can be a top surface of the speaker body 4. The second electrical connector 2 is used as a power output port or a power input port. The second surface 42 includes at least two corresponding contacting surfaces 21. The contacting surfaces 21 comprise a sound surface and a grounding surface. In this embodiment, there are three contacting surfaces 21. The contacting surfaces 21 are located on the second surface 42. On the contacting surface 21, there is a positioning hole 211 that corresponds to the contacting pin 11. The contacting surfaces 21 are arranged in a circular track, and are disposed at a distance to each other to form concentric circles. The first electrical connector 1 and the second electrical connector 2 correspond to each other, and are electrically connected together via a conducting line (not labeled). The contacting pins 11 are electrically connected with the contacting surfaces 21. In a more detail, the sound pins correspond to the sound surfaces, and the grounding pins correspond to sound surfaces. The first electrical connector 1 or the second electrical connector 2 of the speaker body 4 is used to connect to a second electrical connector 2 or a first electrical connector 1 of another speaker body 5. Thereby, the speaker apparatus is expandable.

The jointing structure 3 includes a first jointing part 31, and a second jointing part 32. The first jointing part 31 is located on the first surface 41. The first surface 41 can be a bottom surface of the speaker body 4. The second jointing part 32 is located on the second surface 42. The second surface 42 can be a top surface of the speaker body 4. The second jointing part 32 is located at the center of the concentric circles formed by the contacting surfaces 21. The first jointing part 31 and the second jointing part 32 correspond to each other. The first jointing part 31 or the second jointing part 32 of the speaker body 4 is used for connecting to a second jointing part 32 or a first jointing part 31 of another speaker body 5.

In a preferred embodiment, the jointing structure 3 is a magnetic-attaching structure. The first jointing part 31 and the second jointing part 32 are a magnet-to-magnet set, or a magnet-to-metal set.

When the speaker body 4 is assembled with another speaker body 5, the contacting pin 11 of the first electrical connector 1 of another speaker body 5 is connected to the positioning hole 211 of the contacting surface 21 of the second electrical connector 2 of the speaker body 4. The first jointing part 31 of another speaker body 5 is jointed to the second jointing part 32 of the speaker body 4. Thereby, the speaker body 4 is electrically connected with another speaker body 5 via the first electrical connector 1, the second electrical connector 2, and a jointing structure 3. The connection between the speaker body 4 and another speaker body 5 does not require conducting lines. The goal of expanding the speaker apparatus is achieved, and the difficulty of assembling a plurality of speaker devices in serial via the conducting line is overcome.

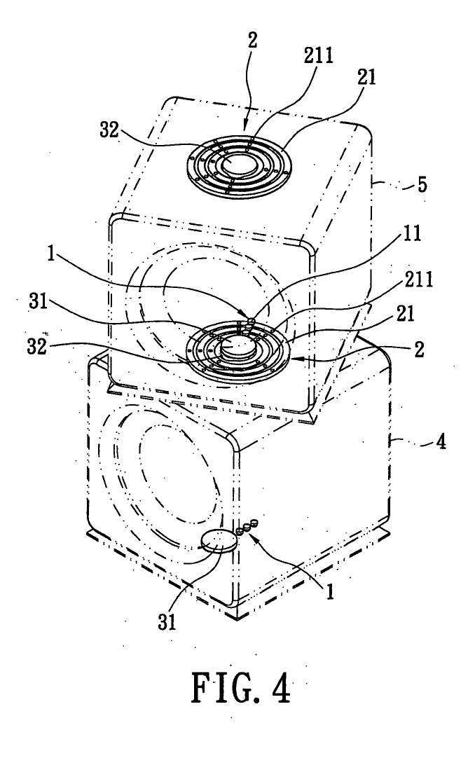

Reference is made to FIG. 4, which shows another assembly schematic diagram of the expandable speaker apparatus of the first embodiment and another first embodiment of the present invention. The contacting surfaces 21 of the second electrical connector 2 of the speaker body 4 form a circular track. The positioning holes 211 are located on the circular track. The second jointing part 32 of the speaker body 4 is located at the center of the concentric circles formed by the contacting surfaces 21. Therefore, the contacting pin 11 of the first electrical connector 1 of another speaker body 5 can rotate according to the positioning hole 211 of the contacting surface 21 of the second electrical connector 2 of the speaker body 4 and changes its location. As shown in FIG. 4, another speaker body 5 is stacked upon the speaker body 4 at an angle.

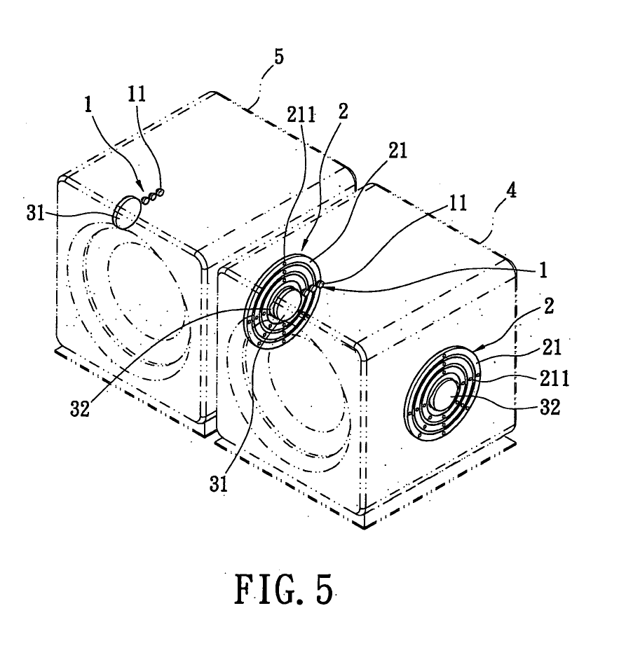

Reference is made to FIG. 5, which shows an assembled schematic diagram of the expandable speaker apparatus of the second embodiment and another second embodiment of the present invention. The second electrical connector 2 and the first electrical connector 1 are located on two opposite side surfaces of the speaker body 4 or another speaker body 5. The first jointing part 31 and the second jointing part 32 are also located on two opposite side surfaces of the speaker body 4 or another speaker body 5. The structure and the connecting relationship of the contacting pins 11 and the positioning holes 211 of the contacting surfaces 21 are the same as the first embodiment.

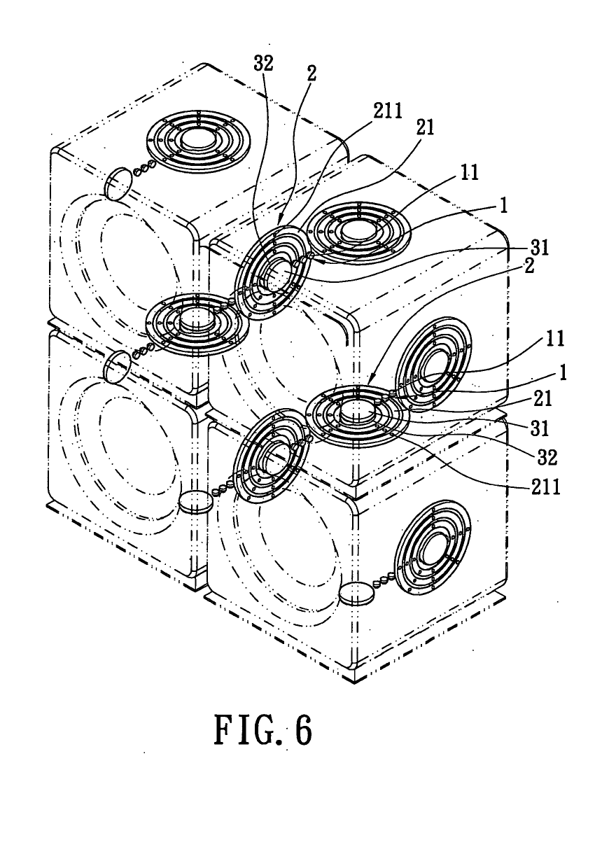

Reference is made to FIG. 6, which shows an assembly schematic diagram of the expandable speaker apparatus of the third embodiment and another third embodiment of the present invention. On the top, and bottom surfaces of each of the speaker body, there is a first electrical connector 1 and a second electrical connector 2 that correspond to each other, and a first jointing part 31 and a second jointing part 32 that correspond to each other. On the left, and right side surfaces of each of the speaker body, there is a first electrical connector 1 and a second electrical connector 2 that correspond to each other, and a first jointing part 31 and a second jointing part 32 that correspond to each other. Thereby, a speaker body having the first electrical connector 1 and the second electrical connector 2 can electrically connected to the top, bottom, left side, or right side surfaces of the speaker body. Therefore, the number of speaker bodies for the speaker apparatus is expanded. The structure and the connecting relationship of the contacting pins 11 and the positioning holes 211 of the contacting surfaces 21 are the same as the previous embodiments.

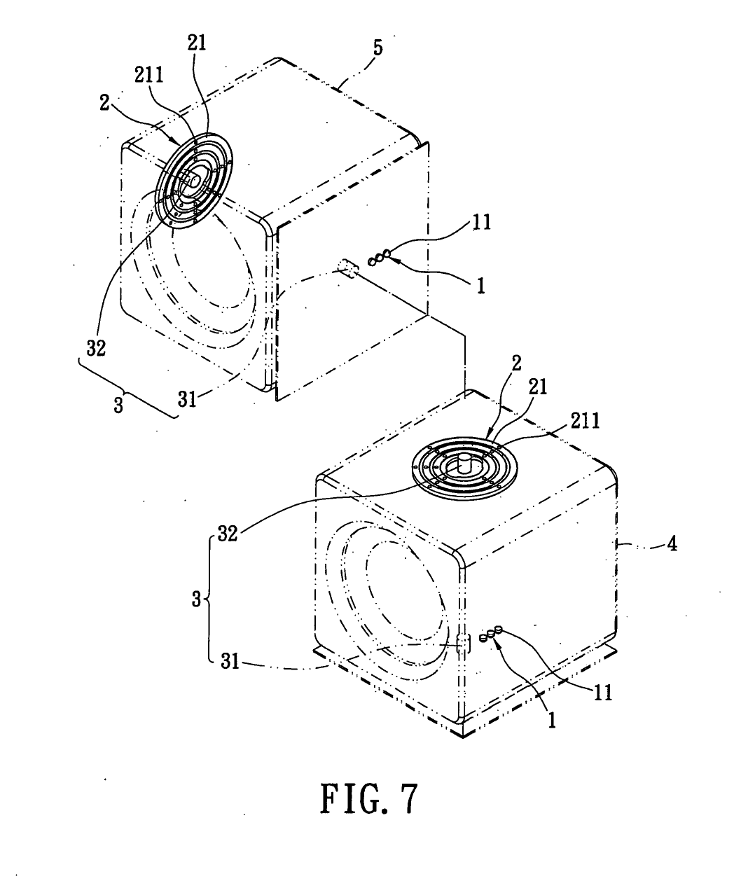

Reference is made to FIG. 7, which shows a schematic diagram of the expandable speaker apparatus of the fourth embodiment of the present invention. The jointing structure 3 uses a tenon structure. The first jointing part 31 and the second jointing part 32 are a tenon-to-mortise set. The other structures are the same as previous embodiments.

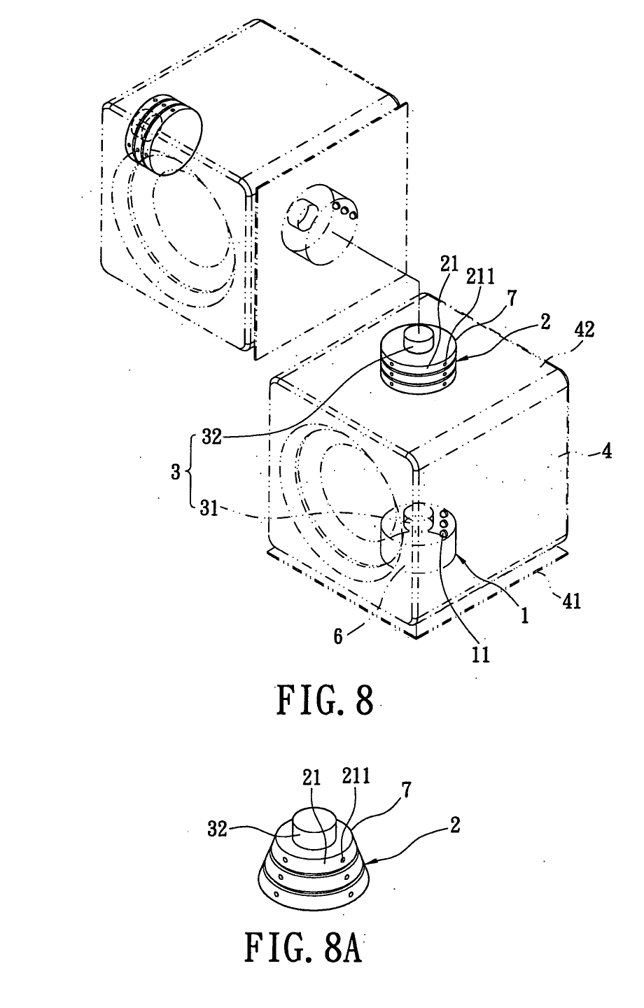

Reference is made to FIG. 8, which shows a schematic diagram of the expandable speaker apparatus of the fifth embodiment of the present invention. The expandable speaker apparatus further includes at least one concave trough 6 and a convex column 7. The concave trough 6 is located on the first surface 41. The convex column 7 is located on the second surface 42.

The first electrical connector 1 includes at least two contacting pins 11. The contacting pins 11 protrude outwards from the external wall surface of the concave trough 6. The second electrical connector 2 includes at least two contacting surfaces 21. The contacting surfaces 21 are located on the external wall surface of the convex column 7. The contacting pins 11 are flexible pins, and the contacting surfaces 21 form a circular track and are disposed at a distance from each other. The contacting pins 11 correspond to the contacting surfaces 21. Thereby, the contacting pins 11 flexibly contact the contacting surfaces 21. The contacting pins 11 comprise of sound pins and grounding pins. The contacting surfaces 21 comprise sound surfaces and grounding surfaces. The sound pins correspond to the sound surfaces, and are electrically connected with the sound surfaces. The grounding pins correspond to the grounding surfaces, and are electrically connected with the grounding surfaces.

The first jointing part 31 is located in the concave trough 6 or on the convex column 7. The second jointing part 32 is located on the convex column 7 or in the concave trough 6. The first jointing part 31 and the second jointing part 32 correspond to each other. The jointing structure 3 is a magnetic-attaching structure. The first jointing part 31 and the second jointing part 32 are a magnet-to-magnet set, or a magnet-to-metal set.

Reference is made to FIG. 8A, which shows a schematic diagram of the expandable speaker apparatus of the sixth embodiment of the present invention. The shape of the concave trough 6 and the convex column 7 is changed to another type that can fit with each other. The other structures are the same as the fifth embodiment.

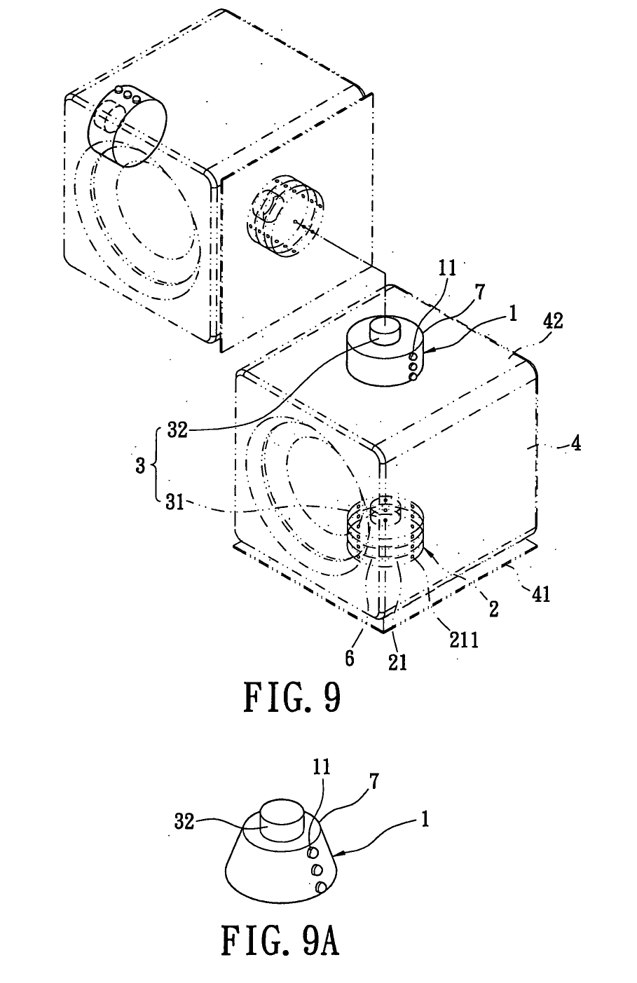

Reference is made to FIG. 9, which shows a schematic diagram of the expandable speaker apparatus of the seventh embodiment of the present invention. The contacting pins 11 of the first electrical connector 1 protrude outwards from the external wall surface of the convex column 7. The contacting surfaces 21 of the second electrical connector 2 are located on the external wall surface of the concave trough 6. The contacting pins 11 correspond to the contacting surfaces 21.

Reference is made to FIG. 9A, which shows a schematic diagram of the expandable speaker apparatus of the eighth embodiment of the present invention. The shape of the concave trough 6 and the convex column 7 is changed to another type that can fit with each other. The other structures are the same as the seventh embodiment.

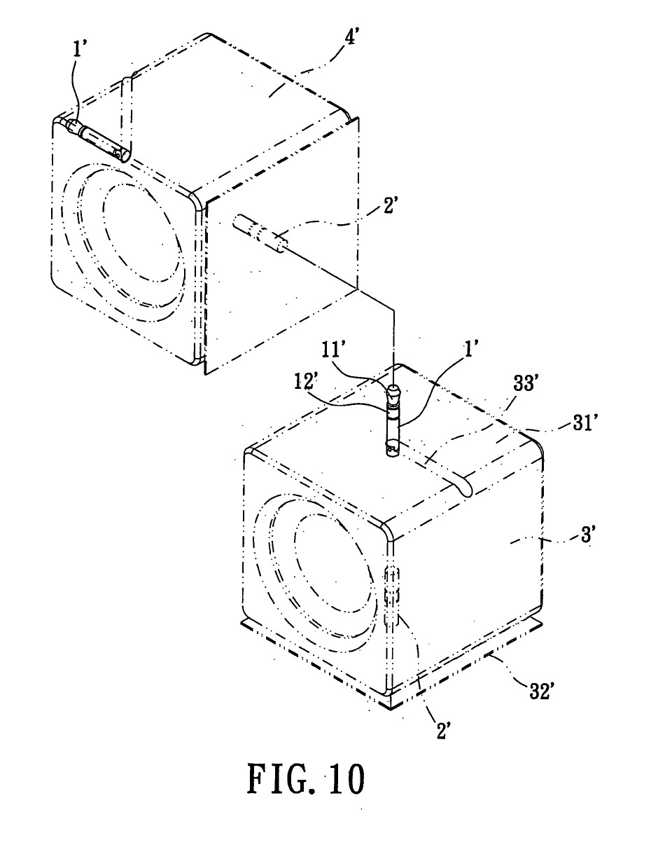

Reference is made to FIG. 10, which shows a schematic diagram of the expandable speaker apparatus of the ninth embodiment of the present invention. The first electrical connector 1′ is a sound-plug connector, and is located on a first surface 31′ of the speaker body 3′. The first surface 31′ can be a top surface of the speaker body 3′. The sound-plug connector is used as a signal-transmitting port. The sound-plug connector includes a sound surface (not labeled), and a grounding surface (not labeled). In this embodiment, the first electrical connector 1′ has at least has two sound channels, including a first sound channel 11′ and a second sound channel 12′.

The second electrical connector 2′ is a sound-socket connector, and is located on a second surface 32′ of the speaker body 3′ that is opposite or adjacent to the first surface 31′. In this embodiment, the second electrical connector 2′ is located on a second surface 32′ of the speaker body 3′ that is opposite to the first surface 31′. The second surface 32′ can be a bottom surface of the speaker body 3′. The sound-socket connector is used as a signal-transmitting port. The sound-socket connector includes a sound pin (not labeled), and a grounding pin (not labeled). The sound pin corresponds to the sound surface, and the grounding pin corresponds to the grounding surface. Thereby, the first electrical connector 1′ and the second electrical connector 2′ correspond to each other to form a sound-plug connector and a sound-socket connector having at least two sound channels. The first electrical connector 1′ is electrically connected with the second electrical connector 2′ via the conducting line (not labeled) in the interior part of the speaker body 3′. The first electrical connector 1′ or the second electrical connector 2′ of the speaker body 3′ is used for connecting to a second electrical connector 2′ or a first electrical connector 1′ of another speaker body 4′. Thereby, the speaker apparatus is expanded.

The speaker body 3′ includes a receiving slot 33′. The receiving slot 33′ is located on the first surface 31′. The first electrical connector 1′ is bendedly received in the receiving slot 33′.

When the speaker body 3′ is assembled with another speaker body 4′, the second electrical connector 2′ of a second speaker body 4′ is connected to the first electrical connector 1′ of the speaker body 3′. Thereby, the speaker body 3′ is electrically connected with a second speaker body 4′ via the first electrical connector 1′, and the second electrical connector 2′. The connection between the speaker body 3′ and a second speaker body 4′ does not require conventional conducting lines. The goal of expanding the speaker apparatus is achieved, and the difficulty of assembling a plurality of speaker devices in serial via the conducting line is overcome.

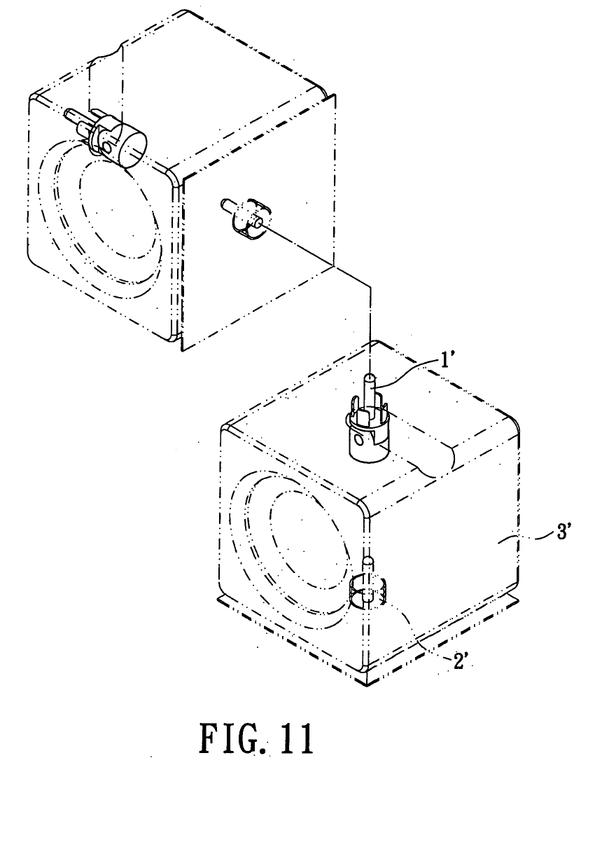

Reference is made to FIG. 11, which shows a schematic diagram of the expandable speaker apparatus of the tenth embodiment of the present invention. The first electrical connector 1′ and the second electrical connector 2′ are changed to a second-typed sound-plug connector and sound-typed sound-socket connector. The second-typed sound-plug connector and sound-typed sound-socket connector include at least two sound channels. The others are the same as previous described in the previous embodiments of the present invention.

The expandable speaker apparatus of the present invention has the following characteristics:

1. A pair of electrical connectors that correspond to each other installed on the external surface of the speaker body is electrically connected with a second speaker body having the same electrical connectors. It does not require a conducting line. The goal of expanding the speaker apparatus is achieved, and the difficulty of assembling a plurality of speaker devices in serial via the conducting lines is overcome.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An expandable speaker apparatus, comprising:
a speaker body;
at least one first electrical connector located on a first surface of the speaker body; and
at least one second electrical connector located on a second surface of the speaker body, wherein the first electrical connector and the second electrical connector correspond to each other, and the first electrical connector is electrically connected with the second electrical connector.

2. The expandable speaker apparatus as claimed in claim 1, wherein the first electrical connector and the second electrical connector are located on the speaker body, and are opposite or adjacent to each other.

3. The expandable speaker apparatus as claimed in claim 2, further comprising at least one jointing structure, wherein the jointing structure comprises a first jointing part, and a second jointing part, the first jointing part is located on the first surface, the second jointing part is located on the second surface, and the first jointing part and the second jointing part correspond to each other.

4. The expandable speaker apparatus as claimed in claim 3, wherein the jointing structure is a magnetic-attaching structure, and the first jointing part and the second jointing part are a magnet-to-magnet set, or a magnet-to-metal set.

5. The expandable speaker apparatus as claimed in claim 3, wherein the jointing structure uses a tenon structure, and the first jointing part and the second jointing part are a tenon-to-mortise set.

6. The expandable speaker apparatus as claimed in claim 3, wherein the first electrical connector at least comprises two contacting pins, the contacting pins protrude outwards from the first surface, the second electrical connector comprises of at least two contacting surfaces located on the second surface, and the contacting pins correspond to the contacting surfaces.

7. The expandable speaker apparatus as claimed in claim 6, wherein the contacting pins comprise of a sound pin and a grounding pin, the contacting surface comprises of a sound surface and a grounding surface, the sound pins correspond to the sound surfaces and are electrically connected with the sound surfaces, and the grounding pins correspond to the sound surfaces and are electrically connected with the grounding surfaces

8. The expandable speaker apparatus as claimed in claim 7, wherein there are positioning holes on the contacting surfaces that correspond to the contacting pins.

9. The expandable speaker apparatus as claimed in claim 8, wherein the contacting pins are flexible pins, and flexibly contact the corresponding contacting surfaces.

10. The expandable speaker apparatus as claimed in claim 9, wherein the contacting surfaces form a circular track, and are disposed to each other at a distance to form concentric circles.

11. The expandable speaker apparatus as claimed in claim 2, further comprising at least one concave trough and a convex column, the concave trough is located on the first surface, the convex column is located on the second surface, the first electrical connector includes at least two contacting pins and the contacting pins protrude outwards from the external wall surface of the concave trough, the second electrical connector includes at least two contacting surfaces and the contacting surfaces are located on the external wall surface of the convex column, and the contacting pins correspond to the contacting surface.

12. The expandable speaker apparatus as claimed in claim 2, further comprising at least one concave trough and a convex column, the concave trough is located on the first surface, the convex column is located on the second surface, the first electrical connector includes at least two contacting pins and the contacting pins protrude outwards from the external wall surface of the convex column, the second electrical connector includes at least two contacting surfaces and the contacting surfaces are located on the external wall surface of the concave trough, and the contacting pins correspond to the contacting surface.

13. The expandable speaker apparatus as claimed in claim 11, further comprising at least one jointing structure having a first jointing part, and a second jointing part, wherein the first jointing part is located on the concave trough or the convex column, the second jointing is located on the convex column or the concave trough, and the first jointing part and the second jointing part correspond to each other.

14. The expandable speaker apparatus as claimed in claim 12, further comprising at least one jointing structure having a first jointing part, and a second jointing part, wherein the first jointing part is located on the concave trough or the convex column, the second jointing is located on the convex column or the concave trough, and the first jointing part and the second jointing part correspond to each other.

15. The expandable speaker apparatus as claimed in claim 13, wherein the jointing structure is a magnetic-attaching structure, and the first jointing part and the second jointing part are a magnet-to-magnet set, or a magnet-to-metal set.

16. The expandable speaker apparatus as claimed in claim 11, wherein the contacting pins comprise a sound pin and a grounding pin, the contacting surface comprises a sound surface and a grounding surface, the sound pins correspond to the sound surfaces and are electrically connected with the sound surfaces, and the grounding pins correspond to the sound surfaces and are electrically connected with the grounding surfaces.

17. The expandable speaker apparatus as claimed in claim 12, wherein the contacting pins comprise a sound pin and a grounding pin, the contacting surface comprises a sound surface and a grounding surface, the sound pins correspond to the sound surfaces and are electrically connected with the sound surfaces, and the grounding pins correspond to the sound surfaces and are electrically connected with the grounding surfaces.

18. The expandable speaker apparatus as claimed in claim 16, wherein there are positioning holes on the contacting surfaces that correspond to the contacting pins.

19. The expandable speaker apparatus as claimed in claim 18, wherein the contacting pins are flexible pins, and flexibly contact the corresponding contacting surfaces.

20. The expandable speaker apparatus as claimed in claim 19, wherein the contacting surfaces form a circular track, and are disposed from each other at a distance.

21. The expandable speaker apparatus as claimed in claim 1, wherein the first electrical connector is a sound-plug connector, and the second electrical connector is a sound-socket connector.

22. The expandable speaker apparatus as claimed in claim 21, wherein the sound-plug connector and the sound-socket connector are adjacently or oppositely located on the speaker body.

23. The expandable speaker apparatus as claimed in claim 21, wherein the sound-socket connector comprises a sound pin and a grounding pin, the sound-plug connector comprising a sound surface and a grounding surface, the sound pin corresponds to the sound surface, and the grounding pin corresponds to the grounding surface.

24. The expandable speaker apparatus as claimed in claim 21, wherein the speaker body comprises a receiving slot, the receiving slot is located on the first surface, and the sound-plug connector is bendedly received in the receiving slot.

25. The expandable speaker apparatus as claimed in claim 21, wherein the sound-plug connector comprises at least two sound channels, and corresponds to the sound-socket connector.
